(19) United States
(12) Patent Application Publication
(10) Pub. No.: US 2026/0188183 A1
(43) Pub. Date: Jul. 2, 2026

(54) DISPLAY PANEL AND DISPLAY APPARATUS

(71) Applicant: Tianma Advanced Display Technology Institute (Xiamen) Co., Ltd., Xiamen (CN)

(72) Inventors: Zhenyu JIA, Xiamen (CN); Yingteng ZHAI, Xiamen (CN); Xin LI, Xiamen (CN); Kerui XI, Xiamen (CN); Yunhua LIU, Xiamen (CN); Bo YANG, Xiamen (CN); Fanqing MENG, Xiamen (CN)

(73) Assignee: Tianma Advanced Display Technology Institute (Xiamen) Co., Ltd., Xiamen (CN)

(21) Appl. No.: 19/228,730

(22) Filed: Jun. 4, 2025

(30) Foreign Application Priority Data
Dec. 31, 2024 (CN) 202411997211.7

(51) Int. Cl. G09G 3/32

(52) U.S. Cl. CPC G09G 3/32; G09G 2320/0633; G09G 2320/064

(57) ABSTRACT

The present application provides a display panel and a display apparatus, wherein the display panel includes a pixel circuit, the pixel circuit includes an amplitude modulation subcircuit and a pulse width modulation subcircuit, the display panel also includes a substrate, a voltage division signal line, and a first constant voltage signal line, the voltage division signal line is located at a side of the substrate, the voltage division signal line extends along a first direction, the first constant voltage signal line is located at the side of the substrate, the first constant voltage signal line extends along a second direction and transmits a high potential voltage to the pulse width modulation subcircuit, and the first direction intersects with the second direction, wherein a plurality of the first constant voltage signal lines are electrically connected to a plurality of the voltage division signal lines.

### CROSS-REFERENCE TO RELATED APPLICATIONS

This application claims priority to Chinese Patent Application No. 202411997211.7, titled “DISPLAY PANEL AND DISPLAY APPARATUS” and filed on Dec. 31, 2024, which is hereby incorporated by reference in its entirety.

### TECHNICAL FIELD

The present application relates to the technical field of display apparatus, and particularly to a display panel and a display apparatus.

### BACKGROUND

With the development of science and technology, the field of display panels has also achieved tremendous progress and diversified development. On this basis, people's requirements for display panels are also increasing day by day. How to improve the reliability of display panels while meeting performance requirements has become one of the research directions of manufacturers.

### SUMMARY

The embodiments of the present application provide a display panel and a display apparatus, which can improve the reliability of the display panel.

In the first aspect, the embodiment of the present application provides a display panel, the display panel comprises a pixel circuit, the pixel circuit comprises an amplitude modulation subcircuit and a pulse width modulation subcircuit, the display panel further comprises a substrate, a voltage division signal line and a first constant voltage signal line, the voltage division signal line is located at a side of the substrate, the voltage division signal line extends along a first direction; the first constant voltage signal line is located at the side of the substrate, the first constant voltage signal line extends along a second direction and transmits a high potential voltage to the pulse width modulation subcircuit, the first direction intersects with the second direction, wherein at least one of the voltage division signal lines is connected to a plurality of the voltage division signal lines.

In the second aspect, the embodiment of the present application provides a display apparatus, the display apparatus includes the display panel in any one of the aforementioned embodiments.

### BRIEF DESCRIPTION OF THE DRAWINGS

In order to more clearly illustrate the technical solution of the embodiments of the present application, the drawings required for use in the embodiments of the present application are briefly introduced below. For those skilled in the art, other drawings can be obtained based on these drawings without creative work.

FIG. 1 is a schematic structural diagram of a local circuit in a display panel provided in an embodiment of the present application;

FIG. 2 is a schematic diagram of a simplified structure of the local circuit in the display panel provided in an embodiment of the present application;

FIG. 3 is a schematic structural diagram of a cross-section at A-A in FIG. 2;

FIG. 4A and FIG. 4B are simplified schematic diagrams of circuits of two pixel circuits in the display panel provided in an embodiment of the present application;

FIG. 5 is a schematic structural diagram of a cross-section at B-B in FIG. 2;

FIG. 6 is a schematic structural diagram of a cross-section at E-E in FIG. 2;

FIG. 7 is a schematic diagram of a simplified structure of a local circuit in another display panel provided in an embodiment of the present application;

FIG. 8 is a schematic diagram of a positional relationship of a first constant voltage signal line, a first data signal line and a second data signal line with respect to a pixel circuit in another display panel provided in an embodiment of the present application;

FIG. 9 is a schematic diagram of a positional relationship of the first constant voltage signal line, a frequency sweep signal line, the first data signal line and the second data signal line with respect to the pixel circuit in another display panel provided in an embodiment of the present application;

FIG. 10 is a schematic diagram of a positional relationship of the first constant voltage signal line with respect to the pixel circuit in another display panel provided in an embodiment of the present application;

FIG. 11 is a schematic diagram of a local structure in another display panel provided in an embodiment of the present application; and

FIG. 12 is a schematic structural diagram of a display apparatus provided in an embodiment of the present application.

### REFERENCE NUMERALS

100, display panel; 200, display apparatus;
10, substrate;
20, first conductor layer; 21, voltage division signal line; 22, control signal line; 23, connecting signal line;
30, second conductor layer; 31, first constant voltage signal line; 32, first data signal line; 321, first sub-data line; 33, second data signal line; 331, second sub-data line; 34, frequency sweep signal line; 341, first type of frequency sweep line; 342, second type of frequency sweep line; 343, third type of frequency sweep line;
P, pixel circuit; P1, pulse width modulation subcircuit; P2, amplitude modulation subcircuit; P3, circuit column; P4, circuit row; P5, circuit group column; C, repeating circuit group; F, light-emitting element; M, transistor;
H1, first avoidance hole; H11, first type of avoidance hole; H12, second type of avoidance hole; H2, second avoidance hole; H3, third avoidance hole;
X, first direction; Y, second direction; Z, thickness direction.

### DETAILED DESCRIPTION

The features and exemplary embodiments of various aspects of the present application will be described in detail below. In order to make the purpose, technical solutions and advantages of the present application clearer, the present application is further described in detail below in conjunction with the drawings and specific embodiments. It should be understood that the specific embodiments described herein are intended only to explain the present application, rather than to limit the present application. For those skilled in the art, the present application can be implemented without some of these specific details. The following description of the embodiments is only to provide a better understanding of the present application by showing examples of the present application.

It should be noted that in the present application, relational terms such as first and second, etc. are only used to distinguish one entity or operation from another entity or operation, and do not necessarily require or imply any such actual relationship or order between these entities or operations. Moreover, the terms “include”, “comprise” or any other variant thereof are intended to cover non-exclusive inclusion, so that a process, method, article or apparatus including a series of elements includes not only those elements, but also other elements not explicitly listed, or also includes elements inherent to such a process, method, article or apparatus. In the absence of further restrictions, the elements defined by the sentence “include . . . ” do not exclude the existence of other identical elements in the process, method, article or apparatus including the elements.

There are many types of display panels. Micro-luminescent display panels have received widespread attention due to their advantages such as higher brightness and wider color gamut. Micro-luminescent display panels use micro devices such as micro light-emitting diodes (Micro Light Emitting Diode, Micro LED) or sub-millimeter light-emitting diodes (Mini Light Emitting Diode, Mini LED) as light-emitting elements to achieve light-emitting display functions. On this basis, how to improve the display reliability of micro-luminescent display panels has become one of the research directions of many manufacturers.

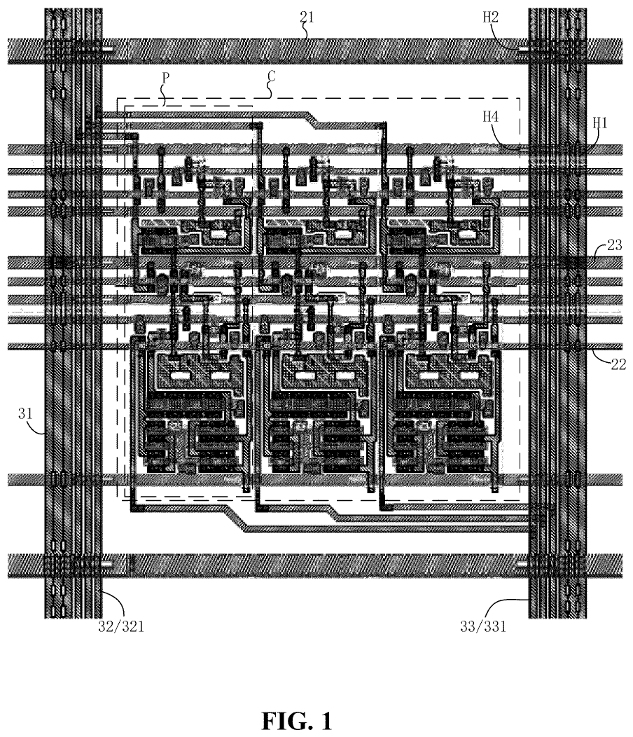

In view of the above problems, in the first aspect, refer to FIG. 1 to FIG. 4, the embodiments of the present application provide a display panel 100, which includes multiple pixel circuits P, the pixel circuit P includes an amplitude modulation subcircuit P2 and a pulse width modulation subcircuit P1, and the display panel 100 also includes a substrate 10, a voltage division signal line 21, and a first constant voltage signal line 31. The voltage division signal line 21 is located at the side of the substrate 10, and the voltage division signal line 21 extends along the first direction X. The first constant voltage signal line 31 is located at the side of the substrate 10, and the first constant voltage signal line 31 extends along the second direction Y and transmits a high potential voltage to the pulse width modulation subcircuit P1. The first direction X intersects with the second direction Y, wherein at least one of the voltage division signal lines 21 is connected to a plurality of the voltage division signal lines 21, optionally, a plurality of the first constant voltage signal lines 31 are electrically connected to a plurality of the voltage division signal lines 21.

The display panel 100 is an apparatus for displaying images. The display panel 100 provided in the embodiments of the present application may be a micro-luminescent display panel 100. Specifically, the display panel 100 may include a light-emitting element F. The light-emitting element F is a main component for realizing the light-emitting function. The light-emitting element F may be a micro light-emitting element F such as a micro light-emitting diode (Micro Light Emitting Diode, Micro LED) or a sub-millimeter light-emitting diode (Mini Light Emitting Diode, Mini LED). The light-emitting element F may have a variety of structural forms, for example, the light-emitting element F may be a flip chip, or a wire-bonding chip, or a vertical chip, which is not limited in the embodiments of the present application.

The pixel circuit P is a circuit structure for driving and controlling whether the light-emitting element F emits light or not. There are multiple pixel circuits P, and the multiple pixel circuits P control different light-emitting elements F to realize the light-emitting function respectively. The pixel circuit P includes a pulse width modulation subcircuit P1 and an amplitude modulation subcircuit P2. The pulse width modulation subcircuit P1 is configured to control the pulse width of the driving current provided to the light-emitting element F based on the pulse width modulation data voltage, and the amplitude modulation subcircuit P2 is configured to control the amplitude of the driving current provided to the light-emitting element F based on the pulse amplitude modulation data voltage. The pulse width of the driving current can be understood as the duration of the driving current, and the amplitude of the driving current can be understood as the magnitude of current value of the driving current.

Specifically, the light-emitting element F includes a first electrode, a second electrode and a light-emitting portion. Under the joint action of the first electrode and the second electrode, the light-emitting portion can realize the light-emitting display function. The pixel circuit P generates a driving current under the control of the amplitude modulation subcircuit P2 and the pulse width modulation subcircuit P1. The amplitude modulation subcircuit P2 can be used to control the amplitude of the driving current, and the pulse width modulation subcircuit P1 can be used to adjust the pulse width of the voltage applied to the second electrode of the light-emitting element F. The pulse width modulation subcircuit P1 adjusts the pulse width of the voltage applied to the second electrode of the light-emitting element F, that is, the pulse width modulation subcircuit P1 adjusts the actual emission period of the driving current applied to the light-emitting element F; at the same time, the driving current applied to the light-emitting element F can be kept at a constant level to adjust the grayscale or brightness displayed by the light-emitting element F, rather than adjusting the grayscale or brightness displayed by the light-emitting element F by adjusting the magnitude of the driving current applied to the light-emitting element F. Therefore, the amplitude modulation subcircuit P2 can provide a driving current to the light-emitting element F so that the light-emitting element F is driven with the best light-emitting efficiency, and adjust the grayscale or brightness displayed by the light-emitting element F by adjusting the light-emitting duty cycle (that is, the emission period of the light-emitting element F) of the light-emitting element F through the pulse width modulation subcircuit P1. The output end of the pulse width modulation subcircuit P1 can be directly connected to the control end of a driving transistor in the amplitude modulation subcircuit P2 or indirectly controlled by a capacitor structure, that is, the electrical signal output by the output end of the pulse width modulation subcircuit P1 can be directly written to the control end of the driving transistor, or written to the capacitor structure to control the control end of the driving transistor, so as to adjust the amplitude of driving current.

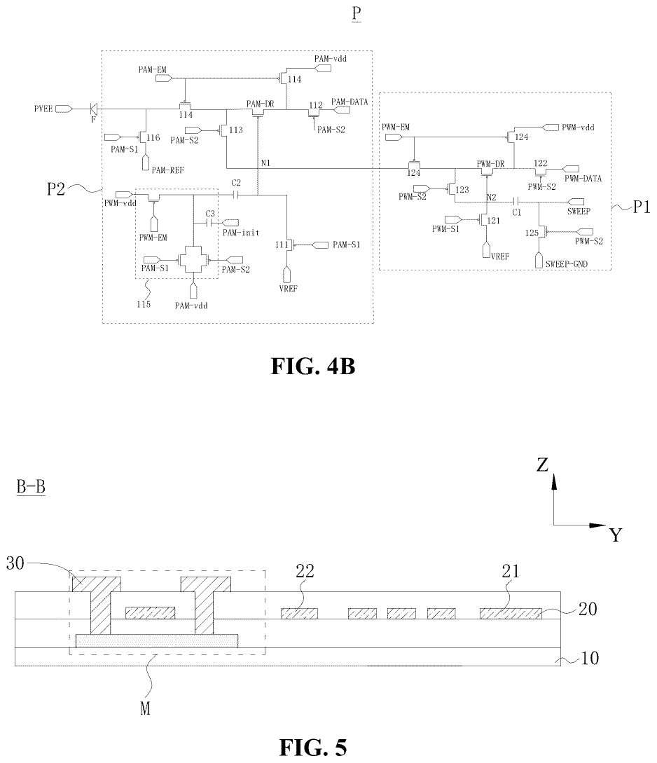

Further, the specific circuit composition of the pulse width modulation subcircuit P1 and the amplitude modulation subcircuit P2 is not limited in the embodiments of the present application. Exemplarily, as shown in FIG. 4A, the pulse width modulation subcircuit P1 includes a first driving transistor M3, a first gate reset transistor M5, a first data writing transistor M2, a first compensation transistor M4, a first control transistor M1, a second control transistor M6 and a storage capacitor Cst. The first control transistor M1 is connected between the first power supply voltage PWM-vdd and the first electrode of the first driving transistor M3, and the second control transistor M6 is connected between the second electrode of the first driving transistor M3 and the first node N1. The first data writing transistor M2 is connected to the first data signal PWM-data and the first electrode of the first driving transistor M3, the first compensation transistor M4 is connected to the second electrode and the control end of the first driving transistor M3, and the first gate reset transistor M5 is connected to the control end of the first driving transistor M3. The first electrode plate of the storage capacitor Cst is connected to the control end of the first driving transistor M3, and the second electrode plate of the storage capacitor Cst is connected to the frequency sweep signal SWEEP, wherein the control end of the first gate reset transistor M5 receives the first scanning signal PWM-S1, and the control ends of the first data writing transistor M2 and the first compensation transistor M4 receive the second scanning signal PWM-S2. The control ends of the first control transistor M1 and the second control transistor M6 receive the first light-emitting control signal PWM-EM.

The amplitude modulation subcircuit P2 includes a second driving transistor M9, a second gate reset transistor M11, a second data writing transistor M8, a second compensation transistor M10, a third control transistor M7, a fourth control transistor M12, and an electrode reset transistor M13. The third control transistor M7 is connected between the second power supply voltage PAM-vdd and the first electrode of the second driving transistor M9, and the fourth control transistor M12 is connected between the second electrode of the second driving transistor M9 and the light-emitting element F. The second driving transistor M9 is configured to generate a driving current under the control of its control end voltage, that is, the voltage of the first node N1. The second data writing transistor M8 is connected to the second data signal PAM-data and the first electrode of the second driving transistor M9, the second compensation transistor M10 is connected to the second electrode and the control end of the second driving transistor M9, the second gate reset transistor M11 is connected to the control end of the second driving transistor M9, the electrode reset transistor M13 is connected to the second electrode of the light-emitting element F, the fourth control transistor M12 is also connected to the second electrode of the light-emitting element F, and the first electrode of the light-emitting element F is connected to the third power supply voltage PVEE; the control end of the second gate reset transistor M11 receives the third scanning signal PAM-S1; the control ends of the second data writing transistor M8, the second compensation transistor M10 and the electrode reset transistor M13 receive the fourth scanning signal PAM-S2. The control ends of the third control transistor M7 and the fourth control transistor M12 receive the second light-emitting control signal PAM-EM.

Alternatively, as shown in FIG. 4B, the amplitude modulation subcircuit P2 and the pulse width modulation subcircuit P1 both include an initialization unit 111/121, a data writing unit 112/122, a threshold compensation unit 113/123, a light-emitting control unit 114/124, storage capacitors C1, C2, C3, a compensation module 115, an electrode reset module 116, a voltage stabilization module 125, and a driving transistor PAM-DR/PWM-DR. The amplitude modulation subcircuit P2P2 includes an initialization unit 111, a data writing unit 112, a threshold compensation unit 113, a light-emitting control unit 114, a storage capacitor C2, a voltage stabilization module 125, and a driving transistor PAM-DR; the pulse width modulation subcircuit P1P1 includes an initialization unit 121, a data writing unit 122, a threshold compensation unit 123, a light-emitting control unit 124, storage capacitors C2 and C3, a compensation module 115, an electrode reset module 116, and a driving transistor PWM-DR. The storage capacitor C3 is located in the compensation module 115, and the compensation module 115 also includes multiple transistor structures.

The initialization unit 111/121 is electrically connected between the initialization signal VREF and the first node N11/N12. The initialization unit 111/121 is used to provide the initialization signal VREF (the value of initialization signal provided by the initialization signal end of the amplitude modulation subcircuit P2P2 may be the same as or different from the value of initialization signal of the pulse width modulation subcircuit P1P1. FIG. 4B shows the case where the initialization signal VREF each includes PAM-REF and PWM-REF) to the first node N1 and the second node N2 during the initialization stage. The data writing unit 112/122 is electrically connected between the data signal PAM-DATA/PWM-DATA and the first electrode of the driving transistor PAM-DR/PWM-DR. The control end of the driving transistor PAM-DR/PWM-DR and the first electrode plate of the storage capacitor C2/C1 are electrically connected to the first node N1 and the second node N2. The data writing unit 112/122 is used to provide the data signal PAM-DATA/PWM-DATA to the first node N1 and the second node N2 through the driving transistor PAM-DR/PWM-DR during the data writing stage. The threshold compensation unit 113/123 is electrically connected to the second electrode of the driving transistor PAM-DR/PWM-DR. The threshold compensation unit 113/123 is used to compensate the threshold voltage of the driving transistor PAM-DR/PWM-DR to the first node N1 and the second node N2. The electrode reset module 116 is electrically connected between the reset signal PAM-INIT and the second electrode of the light-emitting element F. The electrode reset module 116 is used to provide the reset signal PAM-INIT to the second electrode during the initialization phase to achieve the reset of the second electrode. The compensation module 115 is electrically connected to the second electrode plate of the storage capacitor C2 to play a compensation role and reduce the problem of voltage drop in the pixel circuit P. The voltage stabilization module 125 is electrically connected between the second electrode plate of the storage capacitor C1 and the voltage stabilization signal SWEEP-GND. The voltage stabilization module 125 is used to stabilize the potential of the second node N2 when the frequency sweep signal SWEEP does not work.

On this basis, whether it is the circuit structure shown in FIG. 4A or the circuit structure shown in FIG. 4B, the pulse width modulation subcircuit P1 needs to be written with the first power supply voltage PWM-vdd to meet the operation requirements of the pixel circuit P, and the output end of the pulse width modulation subcircuit P1 and the control end of the driving transistor in the amplitude modulation subcircuit P2 both are electrically connected to the first node N1. Further, the stability of the first power supply voltage PWM-vdd in the display panel 100 often determines whether the pulse width modulation subcircuit P1 can operate well, thereby affecting whether the first node N1 can be well turned off, that is, it plays a role in controlling the turn-off of the amplitude modulation subcircuit P2 and controlling the light-emitting element F to turn on and off.

In view of this, in the embodiments of the present application, the stability of the first power supply voltage PWM-vdd is improved by adjusting the signal line layout in the display panel 100, thereby improving the display reliability of the display panel 100. Specifically, the display panel 100 includes a substrate 10, a voltage division signal line 21, and a first constant voltage signal line 31. The substrate 10 is a film layer in the display panel 100 that plays a supporting and bearing role. Other film layer structures and device structures are stacked on the substrate 10 in sequence. The stacking arrangement mentioned here means that other film layer structures and device structures are arranged in sequence along the thickness direction Z of the substrate 10. The thickness direction Z of the substrate 10 is usually consistent with the thickness direction Z of other film layers and the thickness direction Z of the display panel 100. For the convenience of description, the thickness direction Z of the substrate 10, the thickness direction Z of the display panel 100, and the thickness direction Z of other film layers are subsequently illustrated in the same direction in the embodiments of the present application.

The first constant voltage signal line 31 is used to transmit a constant voltage signal and transmit a high potential voltage to the pulse width modulation subcircuit P1, that is, the first constant voltage signal line 31 is used to transmit the first power supply voltage PWM-vdd. The voltage division signal line 21 is connected to the first constant voltage signal line 31, that is, the voltage division signal line 21 is also used to transmit the first power supply voltage PWM-vdd. According to different actual needs, the first constant voltage signal line 31 can be selectively disposed at the same layer with other signal traces, or can be selectively disposed at the same layer without any signal traces, which is not limited in the embodiments of the present application, and the voltage division signal line 21 is the same.

The first constant voltage signal line 31 extends along the second direction Y, and the voltage division signal line 21 extends along the first direction X. The first direction X and the second direction Y are two directions perpendicular to the thickness direction Z and intersecting with each other. Optionally, the first direction X, the second direction Y and the thickness direction Z are arranged perpendicularly to each other.

In this design, multiple first constant voltage signal lines 31 and multiple voltage division signal lines 21 intersect with one another and are distributed in a grid shape, which is conducive to reducing the resistance value of the whole composed of multiple first constant voltage signal lines 31 and multiple voltage division signal lines 21, and reducing the voltage loss value of the first power supply voltage PWM-vdd transmitted in the first constant voltage signal line 31 and the voltage division signal line 21, thereby improving the stability of the first power supply voltage PWM-vdd, improving the turn-off reliability at the first node PAM-N1, so that the light-emitting element F can be accurately turned on and off, thereby improving the display reliability of the display panel 100.

It should be noted that since the first constant voltage signal line 31 and the voltage division signal line 21 are two trace structures located at the same side of the substrate 10 and extending in different directions, and in order to reduce the interference effect of the first constant voltage signal line 31 on other signal traces at the same layer as the voltage division signal line 21, or reduce the interference effect of the voltage division signal line 21 on other signal traces at the same layer as the first constant voltage signal line 31, the first constant voltage signal line 31 and the voltage division signal line 21 need to be located in different film layer structures, that is, the first constant voltage signal line 31 and the voltage division signal line 21 are located at different heights in the thickness direction Z, and the two can be electrically connected by vias at least partially at the intersection position.

The specific film layer positions, material compositions, shapes and sizes, etc. of the first constant voltage signal line 31 and the voltage division signal line 21 are not limited in the embodiments of the present application. Exemplarily, the first constant voltage signal line 31 can be located at the side of the voltage division signal line 21 facing the substrate 10, or can be located at the side of the voltage division signal line 21 away from the substrate 10. The first constant voltage signal line 31 and the voltage division signal line 21 may include the same material, or may include different materials. The width of the first constant voltage signal line 31 in the first direction X may be greater than, equal to, or less than the width of the voltage division signal line 21 in the second direction Y.

In addition, the specific positional relationship of the first constant voltage signal line 31 and the voltage division signal line 21 with respect to the pixel circuit P is not limited in the embodiments of present application, as long as the voltage division signal line 21 is not directly connected to the pixel circuit P, but is at least electrically connected to the pixel circuit P through the first constant voltage signal line 31. The orthographic projection of the first constant voltage signal line 31 on the substrate 10 may overlap the orthographic projection of the pixel circuit P on the substrate 10, and the two are directly connected, or the orthographic projection of the first constant voltage signal line 31 on the substrate 10 may also be located outside the orthographic projection of the pixel circuit P on the substrate 10, in which case the first constant voltage signal line 31 needs to be electrically connected to the pixel circuit P through other signal traces except the voltage division signal line 21. As for the voltage division signal line 21, the orthographic projection of the voltage division signal line 21 on the substrate 10 can overlap the orthographic projection of the pixel circuit P on the substrate 10, or can also be located outside the orthographic projection of the pixel circuit P on the substrate 10.

In summary, in the embodiments of the present application, by adding a voltage division signal line 21 in the display panel 100, and cross-connecting the voltage division signal line 21 with the first constant voltage signal line 31, a mesh structure for transmitting the first power supply voltage PWM-vdd is formed, which is conducive to reducing the voltage loss value of the first power supply voltage PWM-vdd during the transmission process and improving the stability of the first power supply voltage PWM-vdd. In addition, the turn-off reliability at the first node N1 is improved, so that the light-emitting element F can be turned on and off accurately, and the display reliability of the display panel 100 is improved.

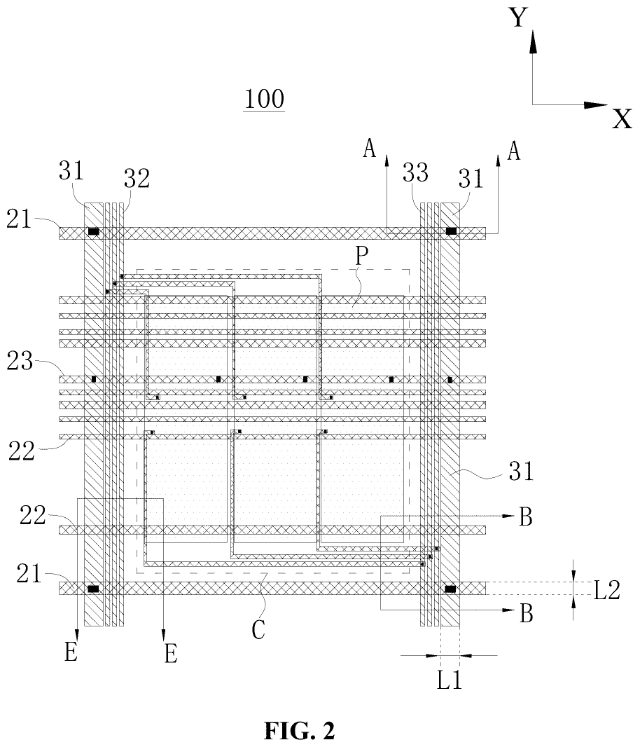

In some embodiments, refer to FIG. 2 and FIG. 5, the display panel 100 includes a first conductor layer 20 located at the side of the substrate 10, and the first conductor layer 20 includes a control signal line 22 and a voltage division signal line 21 extending along the first direction X, and the control signal line 22 and the voltage division signal line 21 are arranged in the second direction Y.

The first conductor layer 20 is a film layer structure located at the side of the substrate 10 and includes a conductive material. The control signal line 22 and the voltage division signal line 21 are both disposed on the first conductor layer 20, that is, the control signal line 22 and the voltage division signal line 21 are disposed on the same layer. Furthermore, the control signal line 22 and the voltage division signal line 21 may include the same conductive material and be prepared and formed together in the same preparation process.

Combined with the above content, it can be known that the pixel circuit P includes multiple transistors M, each of which includes a control end, a first electrode, a second electrode and an active structure. The active structure includes a channel region and a first region and a second region located at both sides of the channel region. The first region is electrically connected to the first electrode, and the second region is electrically connected to the second electrode. The orthographic projection of the control end on the substrate 10 overlaps the orthographic projection of the channel region on the substrate 10. The control end is used to control whether the first electrode and the second electrode are turned on or off, and the first electrode and the second electrode are usually located at the side of the control end away from the substrate 10.

As for the control signal line 22, the control signal line 22 is a trace structure located in the first conductor layer 20 and used to control the signal corresponding to the control end in the transistor. Specifically, the display panel 100 also includes an active layer, and the active structure is located in the active layer, and at least part of the active structures of different transistors can be connected as a whole. On this basis, part of structure of the control signal line 22 that overlaps the orthographic projection of the active layer on the substrate 10 is the control end of the corresponding transistor.

It should be noted that the control signal line 22 has various types of forms. For example, the control signal line 22 can be used to control the control end of at least one of the driving transistor, gate reset transistor, data writing transistor, compensation transistor and control transistor in the pulse width modulation subcircuit P1, or the control signal line 22 can also be used to control the control end of at least one of the driving transistor, gate reset transistor, electrode reset transistor, data writing transistor, compensation transistor and control transistor in the amplitude modulation subcircuit P2.

Further, the first conductor layer 20 can include only one signal type of control signal lines 22, or can also include multiple signal types of control signal lines 22, that is, different control signal lines 22 in the first conductor layer 20 can be used to control only the control end of one of the above-mentioned multiple transistors, or can also control the control ends of different types of transistors respectively.

In addition, the control signal line 22 and the voltage division signal line 21 have the same extension direction, and both extend along the first direction X and are arranged in the second direction Y, so that the control signal line 22 and the voltage division signal line 21 can be arranged in parallel with each other, thereby reducing the risk of contact interference between the two and improving the reliability of internal signal transmission of the control signal line 22 and the voltage division signal line 21.

In the embodiments of the present application, the voltage division signal line 21 and the control signal line 22 are both disposed in the first conductor layer 20, that is, the arrangement of the voltage division signal line 21 does not cause the display panel 100 to be added with a new film layer structure, so that the voltage division signal line 21 for transmitting the first power supply voltage PWM-vdd can be formed without adding a new film layer structure, which is conducive to the thin and light design of the display panel 100. At the same time, the voltage division signal line 21 and the control signal line 22 can include the same material and be prepared together in the same preparation process, which is conducive to simplifying the preparation process of the display panel 100 and improving production efficiency.

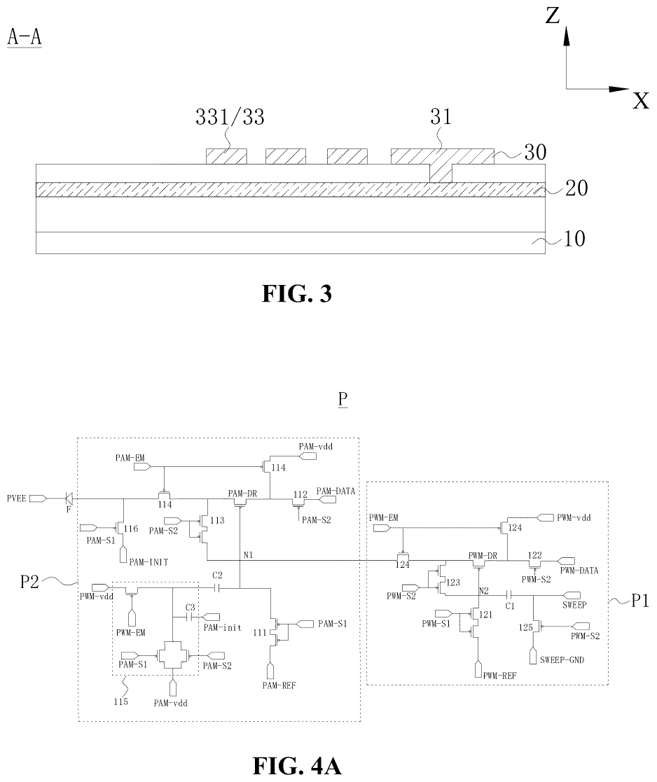

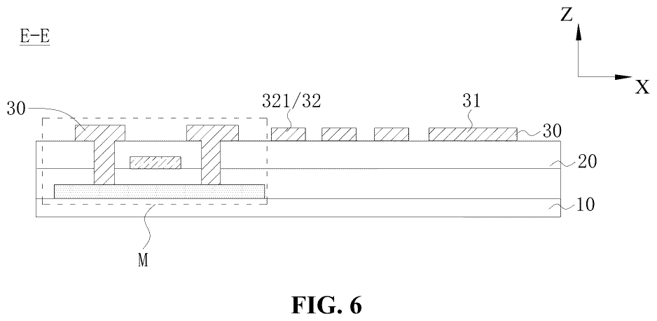

In some embodiments, refer to FIG. 2, FIG. 3 and FIG. 6, the display panel 100 further includes a second conductor layer 30 disposed at the side of the first conductor layer 20 away from the substrate 10, and the first constant voltage signal line 31 is located in the second conductor layer 30.

In the embodiments of the present application, the second conductor layer 30 is a film layer structure including a conductive material and located at the side of the first conductor layer 20 away from the substrate 10 in the display panel 100. Since the voltage division signal line 21 is located in the first conductor layer 20 and the first constant voltage signal line 31 is located in the second conductor layer 30, the first constant voltage signal line 31 may be located at the side of the voltage division signal line 21 away from the substrate 10. This design can make the first constant voltage signal line 31 and the voltage division signal line 21 form a mesh structure collectively to reduce the voltage loss value of the first power supply voltage PWM-vdd during transmission. It can also reduce the contact interference between the first constant voltage signal line 31 and the control signal line 22 located in the first conductor layer 20, thereby improving the signal transmission reliability corresponding to the first power supply voltage PWM-vdd and the control signal.

It should be noted that the first constant voltage signal line 31 can have a variety of positional relationships with respect to the first electrode and the second electrode of the transistor M in the pixel circuit P. Exemplarily, if the orthographic projection of the first constant voltage signal line 31 on the substrate 10 overlaps the orthographic projection of the pixel circuit P on the substrate 10, that is, the orthographic projection corresponding to the first constant voltage signal line 31 may pass through the orthographic projection corresponding to the pixel circuit P along the second direction Y, the first constant voltage signal line 31 needs to be located at the side of the first electrode and second electrode away from the substrate 10, that is, the second conductor layer 30 is located at the side of the film layer where the first electrode and second electrode are located away from the substrate 10, so as to reduce the interference between the first constant voltage signal line 31 and the part of the transistor that is not used to connect the first power supply voltage PWM-vdd.

If the orthographic projection of the first constant voltage signal line 31 on the substrate 10 is located outside the orthographic projection of the pixel circuit P on the substrate 10, that is, the orthographic projection corresponding to the first constant voltage signal line 31 may not pass through the orthographic projection corresponding to the pixel circuit P, the first constant voltage signal line 31 can be disposed in the same layer as the first electrode and the second electrode, that is, the first electrode and second electrode of the transistor in the pixel circuit P can also be located in the second conductor layer 30.

In some embodiments, as shown in FIG. 2, FIG. 3 and FIG. 6, the second conductor layer 30 further includes a first data signal line 32 and a second data signal line 33, the first data signal line 32 is used to transmit a first data signal PWM-data to the pulse modulation subcircuit, and the second data signal line 33 is used to transmit a second data signal PAM-data to the amplitude modulation subcircuit P2. The first data signal line 32 and the second data signal line 33 both extend along the second direction Y, and the first constant voltage signal line 31, the first data signal line 32 and the second data signal line 33 are arranged in the first direction X.

The first data signal line 32, the second data signal line 33 and the first constant voltage signal line 31 are all located in the second conductor layer 30, and the three may include the same material and are formed together in the same preparation process. There are a variety of positional relationships between the first data signal line 32, the second data signal line 33 and the first constant voltage signal line 31. For example, among the three signal traces of the first data signal line 32, the second data signal line 33 and the first constant voltage signal line 31, which are closest to each other, the first data signal line 32 and the second data signal line 33 can be disposed adjacent to each other, and the first constant voltage signal line 31 is located at the same side of the two data lines, or the first constant voltage signal line 31 can also be located between the first data signal line 32 and the second data signal line 33.

Further, similar to the first constant voltage signal line 31, the first data signal line 32 and the second data signal line 33 can also have a variety of positional relationships with respect to the pixel circuit P, for example, the orthographic projection of one of the first data signal line 32 and the second data signal line 33 on the substrate 10 can overlap the orthographic projection of the pixel circuit P on the substrate 10, or the orthographic projections of the first data signal line 32 and the second data signal line 33 on the substrate 10 can also be located outside the orthographic projection of the pixel circuit P on the substrate 10.

In the embodiments of the present application, considering that the extension direction of the first data signal line 32, the second data signal line 33 and the first constant voltage signal line 31 are all the second direction Y, the first data signal line 32, the second data signal line 33 and the first constant voltage signal line 31 are all arranged in the second conductor layer 30 and arranged in the first direction X, so that the number of film layers in the display panel 100 can be reduced while meeting the need for the three signal traces to extend independently of one another, which is conducive to the thin and light design. Further, the first data signal line 32, the second data signal line 33 and the first constant voltage signal line 31 can also include the same material and be prepared together in the same preparation process, which is conducive to simplifying the preparation process of the display panel 100 and improving production efficiency.

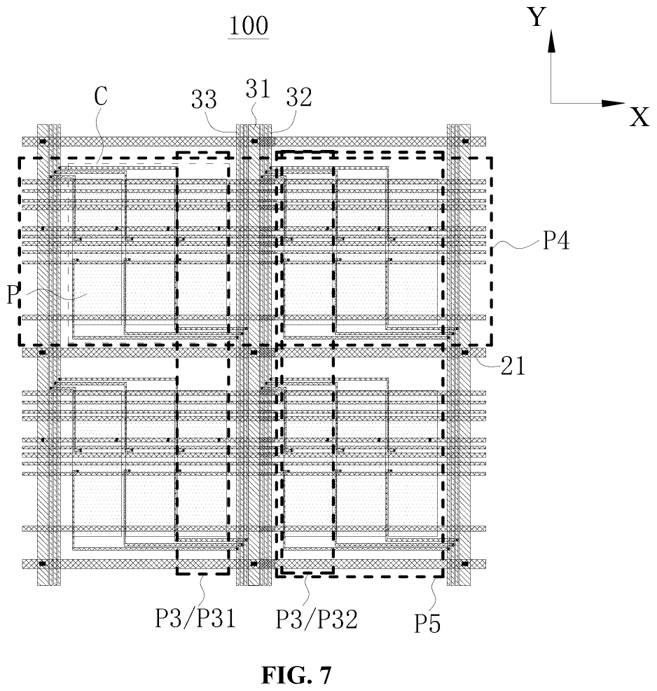

In some embodiments, refer to FIG. 5 and FIG. 7, the orthographic projection of the voltage division signal line 21 on the substrate 10 is outside the orthographic projection of the pixel circuit P on the substrate 10, that is, the projection of the voltage division signal line 21 in the thickness direction Z does not overlap the projection of the pixel circuit P in the thickness direction Z.

In the embodiments of the present application, although the voltage division signal line 21 is used to transmit the first power supply voltage PWM-vdd, the voltage division signal line 21 is not directly connected to the pixel circuit P, but needs to be electrically connected to the pixel circuit P with the help of at least the first constant voltage signal line 31. On this basis, by displacing the voltage division signal line 21 with the orthographic projection corresponding to the pixel circuit P, the risk of contact interference of the voltage division signal line 21 with respect to the device structure such as the transistor in the pixel circuit P can be reduced, thereby improving the operation reliability of the pixel circuit P. Furthermore, at least part of the device structures in the pixel circuit P can be located in the first conductor layer 20, that is, arranged in the same layer as the voltage division signal line 21, so as to improve the space utilization rate of the first conductor layer 20 and facilitate the thin and light design.

In some embodiments, as shown in FIG. 5 and FIG. 7, multiple pixel circuits P arranged in the second direction Y form a circuit column P3, and orthographic projections of at least part of the first constant voltage signal lines 31 on the substrate 10 are located between orthographic projections of the adjacent circuit columns P3 on the substrate 10; and/or, multiple pixel circuits P arranged in the first direction X form a circuit row P4, and orthographic projections of at least part of the voltage division signal lines 21 on the substrate 10 are located between orthographic projections of the adjacent circuit rows P4 on the substrate 10.

The first direction X corresponds to the row direction in which the multiple pixel circuits P are arranged, and the multiple pixel circuits P passed by a virtual straight line parallel to the first direction X collectively form a circuit row P4, and the multiple circuit rows P4 are arranged in the second direction Y. The second direction Y corresponds to the column direction in which the multiple pixel circuits P are arranged, and the multiple pixel circuits P passed by a virtual straight line parallel to the second direction Y collectively form a circuit column P3, and the multiple circuit columns P3 are arranged in the first direction X.

For the two circuit rows P4 that are closest to each other, there is a gap space extending along the first direction X between the two. On this basis, since the voltage division signal line 21 also extends along the first direction X, and the voltage division signal line 21 is not directly connected to the pixel circuit P, the voltage division signal line 21 can be disposed between two adjacent circuit rows P4. Only one voltage division signal line 21 can be disposed between two adjacent circuit rows P4, or multiple voltage division signal lines 21 can be disposed between two adjacent circuit rows P4 at the same time.

Similarly, for the two circuit columns P3 that are closest to each other, there is a gap space extending along the second direction Y between the two. On this basis, since the first constant voltage signal line 31 also extends along the second direction Y, the first constant voltage signal line 31 can be disposed between two adjacent circuit columns P3. Only one first constant voltage signal line 31 can be disposed between two adjacent circuit columns P3, or multiple first constant voltage signal lines 31 can be disposed between two adjacent circuit columns P3 at the same time.

It should be noted that, for the solution in which the first constant voltage signal line 31 is located between adjacent circuit columns P3, since the first constant voltage signal line 31 does not overlap the pixel circuit P, the two cannot be directly connected. On this basis, other signal traces are also required to be disposed in the display panel 100 to realize the electrical connection between the first constant voltage signal line 31 and the pixel circuit P, so as to meet the transmission need of the first power supply voltage PWM-vdd.

In the embodiments of the present application, by disposing the voltage division signal line 21 between two adjacent circuit rows P4, or disposing the first constant voltage signal line 31 between two circuit columns P3, while meeting the corresponding extension needs of the voltage division signal line 21 or the first constant voltage signal line 31, the risk of contact interference between the voltage division signal line 21 or the first constant voltage signal line 31 and the device structure in the pixel circuit P is reduced, thereby improving the reliability of the corresponding signal transmission and the operation reliability of the pixel circuit P.

In some optional embodiments, multiple pixel circuits P arranged in the second direction Y form a circuit column P3, and orthographic projections of at least part of the first constant voltage signal lines 31 on the substrate 10 are located between orthographic projections of the adjacent circuit columns P3 on the substrate 10; and multiple pixel circuits P arranged in the first direction X form a circuit row P4, and orthographic projections of at least part of the voltage division signal lines 21 on the substrate 10 are located between orthographic projections of the adjacent circuit rows P4 on the substrate 10.

In some embodiments, as shown in FIG. 2, FIG. 3, FIG. 6 and FIG. 7, the display panel 100 further includes a first data signal line 32 and a second data signal line 33 extending along the second direction Y, and orthographic projections of at least part of the first data signal lines 32 and the second data signal lines 33 on the substrate 10 are located between the orthographic projections of the adjacent circuit columns P3 on the substrate 10. The distance between the circuit column P3 and the first data signal line 32 electrically connected thereto in the first direction X is smaller than the distance between the circuit column P3 and the first constant voltage signal line 31 in the first direction X; and/or, the distance between the circuit column P3 and the second data signal line 33 electrically connected thereto in the first direction X is smaller than the distance between the circuit row P4 and the first constant voltage signal line 31 in the first direction X.

In combination with the foregoing, it can be seen that the first data signal line 32 is used to transmit the first data signal PWM-data to the pulse modulation subcircuit, and the second data signal line 33 is used to transmit the second data signal PAM-data to the amplitude modulation subcircuit P2. Since both the first data signal line 32 and the second data signal line 33 extend along the second direction Y, the first data signal line 32 and the second data signal line 33 can also be correspondingly disposed in the gap area between adjacent circuit columns P3. Furthermore, similar to the first constant voltage signal line 31, the first data signal line 32 and the second data signal line 33 also require other signal traces to realize electrical connection with the pixel circuit P.

Considering that the first power supply voltage PWM-vdd may be transmitted through the mesh structure composed of the first constant voltage signal line 31 and the voltage division signal line 21, the resistance corresponding to the signal trace structure for transmitting the first power supply voltage PWM-vdd is usually relatively small, and the corresponding signal delay and other problems are also relatively small. For the first data signal PWM-data and the second data signal PAM-data, they usually only rely on the strip-shaped first data signal line 32 and the second data signal line 33 to realize the transmission of the corresponding signal, which may have a larger resistance value with respect to the first power supply voltage PWM-vdd, that is, it is more likely to cause signal delay problems.

In view of this, in the embodiments of the present application, the position of the first data signal line 32 and the second data signal line 33 with respect to the first constant voltage signal line 31 is adjusted, so as to improve the overall operation reliability of the pixel circuit P, which is described in detail in conjunction with the drawings in the embodiments of the present application below. As shown in FIG. 7, for two circuit columns P3 adjacent to each other, the circuit column on the left is the first circuit column P31, and the circuit column on the right is the second circuit column P32. The first data signal line 32 located between the two needs to be electrically connected to the pixel circuit P in the second circuit column P32 through other signal traces, and the second data signal line 33 located between the two needs to be electrically connected to the pixel circuit P in the first circuit column P31 through other signal traces.

On this basis, in the embodiments of the present application, the distance between the second circuit column P32 and the first data signal line 32 electrically connected thereto in the first direction X is set to be smaller than the distance between the circuit column P3 at the right side and the first constant voltage signal line 31 in the first direction X, that is, the first data signal line 32 is located at the right side of the first constant voltage signal line 31 close to the second circuit column P32. In this way, the extension length of the signal trace required for realizing the electrical connection between the first data signal line 32 and the second circuit column P32 in the first direction X is reduced, and the signal delay problem corresponding to the first data signal PWM-data is reduced. The mesh structure formed by the first constant voltage signal line 31 and the voltage division signal line 21 can reduce the signal delay problem corresponding to the first power supply voltage PWM-vdd. Therefore, the embodiments of the present application can take into account the transmission reliability of the first data signal PWM-data and the first power supply voltage PWM-vdd at the same time, and improve the operation reliability of the pixel circuit P.

Similarly, in the embodiments of the present application, the distance between the first circuit column P31 and the second data signal line 33 electrically connected thereto in the first direction X can also be set to be less than the distance between the first circuit column P31 and the first constant voltage signal line 31 in the first direction X, that is, the second data signal line 33 is located at the left side of the first constant voltage signal line 31 close to the first circuit column P31. In this way, the extension length of the signal trace required for realizing the electrical connection between the second data signal line 33 and the first circuit column P31 in the first direction X is reduced, and the signal delay problem corresponding to the second data signal PAM-data is reduced. The mesh structure composed of the first constant voltage signal line 31 and the voltage division signal line 21 can reduce the signal delay problem corresponding to the first power supply voltage PWM-vdd. Therefore, the embodiments of the present application can take into account the transmission reliability of the second data signal PAM-data and the first power supply voltage PWM-vdd at the same time, and improve the operation reliability of the pixel circuit P.

It should be noted that FIG. 7 shows the situation where the first data signal line 32 and the second data signal line 33 located between two adjacent circuit columns P3 are connected to different circuit columns P3 respectively. In some other embodiments, the first data signal line 32 and the second data signal line 33 located between two adjacent circuit columns P3 can also be electrically connected to the same circuit column P3, for example, both data lines are electrically connected to the first circuit column P31. On this basis, in order to take into account the transmission reliability of the first data signal PWM-data, the second data signal PAM-data and the first power supply voltage PWM-vdd, both the first data signal line 32 and the second data signal line 33 need to be disposed at the left side of the first constant voltage signal line 31, that is, the first data signal line 32 and the second data signal line 33 need to be located at the same side of the first constant voltage signal line 31, rather than being disposed at both sides of the first constant voltage signal line 31 respectively.

In some embodiments, at least part of the adjacent circuit columns P3 are provided with a first constant voltage signal line 31, a first data signal line 32 and a second data signal line 33 therebetween, and the first data signal line 32 and the second data signal line 33 are disposed at both sides of the first constant voltage signal line 31 along the first direction X respectively, and the first data signal line 32 and the second data signal line 33 are electrically connected to the pixel circuits P in the adjacent circuit column P3 respectively.

In the embodiments of the present application, the “the first data signal line 32 and the second data signal line 33 are electrically connected to the pixel circuits in the adjacent circuit column P3 respectively” refers to: corresponding to the first data signal line 32, the circuit column P3 closest to the first data signal line 32 in the first direction X; corresponding to the second data signal line 33, the circuit column P3 closest to the second data signal line 33 in the first direction X.

Combined with FIG. 7, in the embodiments of the present application, the first data signal line 32 and the second data signal line 33 are disposed at both sides of the first constant voltage signal line 31 respectively, and the circuit column P3 electrically connected to the first data signal line 32 is located at the side of the first data signal line 32 away from the first constant voltage signal line 31 and the second data signal line 33, while the circuit column P3 electrically connected to the second data signal line 33 is located at the side of the second data signal line 33 away from the first constant voltage signal line 31 and the first data signal line 32. Under this design, the extension length of the signal trace required for realizing the electrical connection between the first data signal line 32 and the corresponding circuit column P3 in the first direction X may not be adversely affected by the second data signal line 33 and the first constant voltage signal line 31; the extension length of the signal trace required for realizing the electrical connection between the second data signal line 33 and the corresponding circuit column P3 in the first direction X may not be adversely affected by the first data signal line 32 and the first constant voltage signal line 31, thereby further taking into account the transmission reliability of the first data signal PWM-data, the second data signal PAM-data and the first power supply voltage PWM-vdd, and improving the operation reliability of the pixel circuit P.

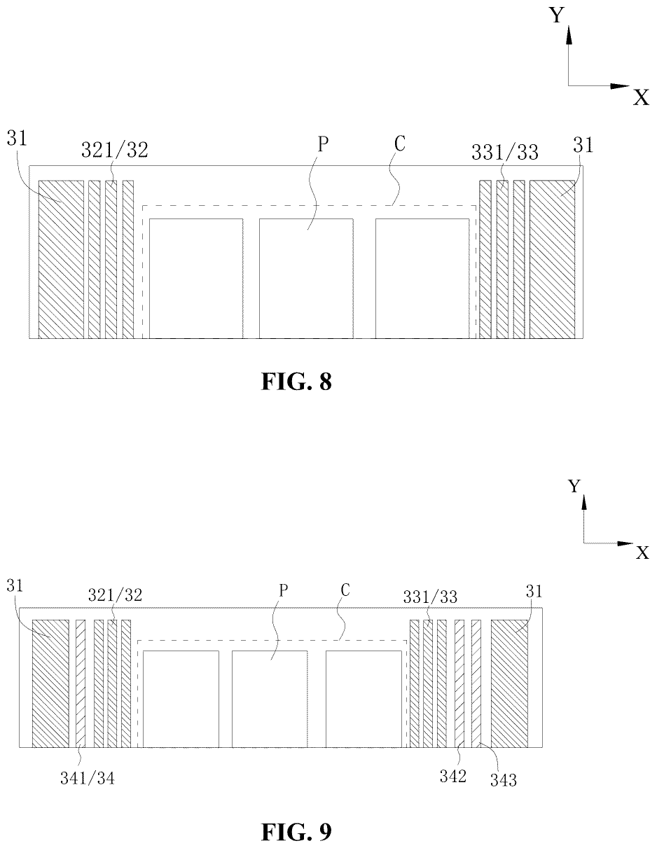

In some embodiments, referring to FIG. 3, FIG. 6, FIG. 7 and FIG. 8, the display panel 100 includes a repeating circuit group C, the repeating circuit group C includes multiple pixel circuits P, and the multiple repeating circuit groups C are repeatedly arranged in the first direction X and the second direction Y, and the first data signal line 32 includes multiple first sub-data lines 321, and the multiple first sub-data lines 321 are connected to different pixel circuits P in the same repeating circuit group C respectively. The second data signal line 33 includes multiple second sub-data lines 331, and the multiple second sub-data lines 331 are electrically connected to different pixel circuits P in the same repeating circuit group C respectively.

The repeating circuit group C is the smallest repeating unit composed of a plurality of pixel circuits P, and the plurality of repeating circuit groups C can be arranged repeatedly along the first direction X and the second direction Y. The distances between adjacent repeating circuit groups C in the first direction X are usually consistent, and the distances between adjacent repeating circuit groups C in the second direction Y are usually consistent. However, according to different actual needs, a special design can be performed at a position close to the edge of the display panel 100. For example, at a position close to the edge, the distance between adjacent repeating circuit groups C in the first direction X may be different from or consistent with that at the center position. Similarly, at a position close to the edge, the distance between adjacent repeating circuit groups C in the second direction Y may be different from or consistent with that at the center position, which are not limited in the embodiments of the present application.

The multiple pixel circuits P in the repeating circuit group C can have multiple types and arrangements. Exemplarily, the repeating circuit group C includes a first pixel circuit P, a second pixel circuit P and a third pixel circuit P arranged along the first direction X. The first pixel circuit P, the second pixel circuit P and the third pixel circuit P are used to drive one of the red light-emitting element, the green light-emitting element and the blue light-emitting element respectively, and the multiple light-emitting elements electrically connected to the multiple pixel circuits P in the same repeating circuit group C together constitute a pixel unit. The pixel unit is the smallest repeating unit in the light-emitting element arrangement structure.

In the display panel 100, in the first direction X, the distance between two adjacent pixel circuits P disposed in two adjacent repeating circuit groups C is often greater than the distance between two adjacent pixel circuits P in the same repeating circuit group C. On this basis, in the embodiments of the present application, the first data signal line 32 and the second data signal line 33 are correspondingly disposed between adjacent repeating circuit groups C, and the first data signal line 32 and the second data signal line 33 disposed in the area where the single repeating circuit group C is located are cancelled, thereby reducing the influence of the first data signal line 32 and the second data signal line 33 on the size of the single repeating circuit group C in the first direction X.

Further, in order to meet the needs of multiple pixel circuits P in a single repeating circuit group C corresponding to different first data signals PWM-data and second data signals PAM-data, in the embodiments of the present application, the first data signal line 32 includes multiple first sub-data lines 321, and the multiple first sub-data lines 321 are used to electrically connect to different pixel circuits P in a single repeating circuit group C respectively, so as to meet the needs of different first data signals PWM-data for multiple pixel circuits P in a single repeating circuit group C. The number of first sub-data lines 321 included in the first data signal line 32 can match the number of pixel circuits P in a single repeating circuit group C. Further, optionally, the arrangement of multiple first sub-data lines 321 in the first data signal line 32 is consistent with the arrangement of multiple pixel circuits P in the corresponding repeating circuit group C.

In the embodiments of the present application, the first data signal line 32 and the second data signal line 33 are correspondingly disposed between adjacent repeating circuit groups C, rather than being correspondingly located at the corresponding area of a single repeating circuit group C, so as to reduce the influence of the first data signal line 32 and the second data signal line 33 on the size of the single repeating circuit group C in the first direction X. Furthermore, in the embodiments of the present application, the first data signal line 32 includes include multiple first sub-data lines 321 corresponding to different pixel circuits P in the same repeating circuit group C, and the second data signal line 33 includes multiple second sub-data lines 331 corresponding to different pixel circuits P in the same repeating circuit group C, so as to meet the transmission needs of the first data signals PWM-data and the second data signals PAM-data of the multiple pixel circuits P in the single repeating circuit group C.

It should be noted that the first constant voltage signal line 31 is also located between adjacent repeating circuit groups C. Considering that multiple pixel circuits P in the same repeating circuit group C can be electrically connected to the same first power supply voltage PWM-vdd at the same time, only one first constant voltage signal line 31 can be disposed between adjacent repeating circuit groups C. In other embodiments, multiple first constant voltage signal lines 31 can also be disposed between adjacent repeating circuit groups C at the same time to improve the transmission reliability of the first power supply voltage PWM-vdd, which is not limited in the embodiments of the present application.

In addition, in conjunction with FIG. 7 and FIG. 8, between adjacent repeating circuit groups C, a plurality of first sub-data lines 321 in the first data signal line 32 are located at the same side of the first constant voltage signal line 31, and a plurality of second sub-data lines 331 in the second data signal line 33 are also located at the same side of the first constant voltage signal line 31, and a plurality of first sub-data lines 321 and a plurality of second sub-data lines 331 are disposed at different sides of the first constant voltage signal line 31 respectively, which is conducive to reducing the distance between the first sub-data line 321 and the corresponding electrically connected pixel circuit P in the first direction X, and reducing the distance between the second sub-data line 331 and the corresponding electrically connected pixel circuit P in the first direction X, thereby taking into account the transmission reliability of the first data signal PWM-data, the second data signal PAM-data and the first power supply voltage PWM-vdd.

In some embodiments, refer to FIG. 9, the display panel 100 further includes a frequency sweep signal line 34 extending along the second direction Y, the frequency sweep signal line 34 is used to transmit a frequency sweep signal SWEEP to the amplitude modulation subcircuit P2, and the frequency sweep signal line 34, the first constant voltage signal line 31, the first data signal line 32 and the second data signal line 33 are arranged in the first direction X.

The frequency sweep signal line 34 is a signal trace for transmitting the frequency sweep signal SWEEP, and the same as the first constant voltage signal line 31, the first data signal line 32 and the second data signal line 33 is that the frequency sweep signal line 34 is also extended along the second direction Y. The frequency sweep signal line 34 can be disposed in the same layer with respect to at least one of the first constant voltage signal line 31, the first data signal line 32 and the second data signal line 33, or can also be located in different conductor film layers with the first constant voltage signal line 31, the first data signal line 32 and the second data signal line 33 at the same time, which is not limited in the embodiments of the present application.

It should be noted that, for ease of understanding, the frequency sweep signal line 34 in FIG. 9 is illustrated in different cross-sectional forms with respect to the first constant voltage signal line 31, the first data signal line 32, and the second data signal line 33, but it does not mean that the frequency sweep signal line 34 needs to be located in different film layers with respect to the first constant voltage signal line 31, the first data signal line 32, and the second data signal line 33.

The specific positional relationship of the frequency sweep signal line 34 with respect to the first constant voltage signal line 31, the first data signal line 32, and the second data signal line 33 is not limited in embodiments of the present application. Exemplarily, the orthographic projection of the frequency sweep signal line 34 on the substrate 10 is also located between two adjacent repeating circuit groups C in the first direction X, and between two adjacent repeating circuit groups C, the frequency sweep signal line 34 can be located between any adjacent other types of signal traces, or can also be located at the same side of multiple other types of signal traces.

On this basis, in the embodiments of the present application, the frequency sweep signal line 34, the first constant voltage signal line 31, the first data signal line 32 and the second data signal line 33 are arranged along the first direction X, so that orthographic projections of the frequency sweep signal line 34, the first constant voltage signal line 31, the first data signal line 32 and the second data signal line 33 on the substrate 10 are spaced from one another in the first direction X, thereby reducing the risk of contact interference and relatively large parasitic capacitance of the above-mentioned signal traces, and improving the reliability of the corresponding signal transmission of the various signal traces.

In some optional embodiments, the frequency sweep signal line 34, the first constant voltage signal line 31, the first data signal line 32 and the second data signal line 33 are all located in the second conductor layer 30, that is, the above-mentioned signal traces are all disposed in the same layer, which is conducive to further reducing the number of film layers in the display panel 100 and facilitating the thin and light design. At the same time, the various signal traces can also include the same material and be formed together in the same process, thereby simplifying the preparation process of the display panel 100 and reducing the preparation cost.

It should be noted that in the embodiments of the present application, the frequency sweep signal SWEEP is transmitted in a direct driving manner. Exemplarily, the display panel 100 also includes a driver chip IC, which is disposed at the side of the substrate 10 away from the first constant voltage signal line 31, wherein the driver chip IC can be directly or indirectly connected to the frequency sweep signal line 34, thereby realizing direct driving of the frequency sweep signal SWEEP.

In other embodiments, the display panel 100 may also include a plurality of shift registers arranged in cascade, the shift registers may be disposed between adjacent circuit rows P4, or between adjacent circuit columns P3, and the output end of the shift register is used to provide the frequency sweep signal SWEEP to meet the transmission needs of the frequency sweep signal SWEEP.

In some embodiments, as shown in FIG. 9, at least part of the frequency sweep signal lines 34 are located between the first data signal line 32 and the first constant voltage signal line 31 that are closest to each other, and the frequency sweep signal line 34 and the first data signal line 32 are electrically connected to the same pixel circuit P; and/or, at least part of the frequency sweep signal lines are located between the second data signal line 33 and the first constant voltage signal line 31 that are closest to each other, and the frequency sweep signal line 34 and the second data signal line 33 are electrically connected to the same pixel circuit P.

The “at least part of the frequency sweep signal lines 34 are located between the first data signal line 32 and the first constant voltage signal line 31 that are closest to each other” mentioned in the embodiments of the present application refers to: for a single frequency sweep signal line 34, the specific first data signal line 32 and the specific first constant voltage signal line 31 that each are the smallest distances from the single frequency sweep signal line 34 in the first direction X. There may be other signal traces between the frequency sweep signal line 34 and the first data signal line 32 closest to the frequency sweep signal line 34, or there may be no other signal traces between the frequency sweep signal line 34 and the first data signal line 32 closest to the frequency sweep signal line 34, which is not limited in the embodiments of the present application, and there is at least a first data signal line 32 between the frequency sweep signal line 34 and the first constant voltage signal line 31 closest to the frequency sweep signal line 34. In addition, the relationship of the frequency sweep signal line 34 with the second data signal line 33 and the first constant voltage signal line 31 closest to the frequency sweep signal line 34 is similar to this, which is not repeated in the embodiments of the present application.

Similar to the first data signal line 32, the second data signal line 33 and the first constant voltage signal line 31, the frequency sweep signal line 34 is also located between adjacent circuit columns P3, and further optionally, the orthographic projection of the frequency sweep signal line 34 on the substrate 10 is located between the orthographic projections of the adjacent repeating circuit groups C on the substrate 10 in the first direction X.

Considering that the first power supply voltage PWM-vdd may be transmitted through the mesh structure composed of the first constant voltage signal line 31 and the voltage division signal line 21, the resistance corresponding to the signal trace structure for transmitting the first power supply voltage PWM-vdd is usually relatively small, and the corresponding signal delay and other problems are also relatively small. For the frequency sweep signal SWEEP, the frequency sweep signal SWEEP is similar to the first data signal PWM-data and the second data signal PAM-data, and only relies on the strip-shaped frequency sweep signal line 34 to realize the transmission of the corresponding signal. The frequency sweep signal line 34 has a larger resistance value with respect to the first power supply voltage PWM-vdd, that is, it is more likely to cause signal delay problems.

In view of this, in the embodiments of the present application, the position of the frequency sweep signal line 34 with respect to the first constant voltage signal line 31 is adjusted to improve the overall operation reliability of the pixel circuit P. For example, between two adjacent circuit columns P3 at the left and right sides, there are a first constant voltage signal line 31, a first data signal line 32, a second data signal line 33 and a frequency sweep signal line 34. The first data signal line 32 is located at the left side of the first constant voltage signal line 31 and is electrically connected to the circuit column P3 at the left side. The second data signal line 33 is located at the right side of the first constant voltage signal line 31 and is electrically connected to the circuit column P3 at the right side.

On this basis, at least part of the frequency sweep signal lines 34 can be located between the first data signal line 32 and the first constant voltage signal line 31 and electrically connected to the circuit column P3 at the left side, that is, at least part of the frequency sweep signal lines 34 and the first data signal line 32 are located at the same side of the first constant voltage signal line 31 and electrically connected to the same pixel circuit P, thereby reducing the sizes of the signal trace for electrically connecting the first data signal line 32 and the pixel circuit P and the signal trace for connecting the frequency sweep signal line 34 and the pixel circuit P in the first direction X, and taking into account the transmission reliability of the first data signal PWM-data and the frequency sweep signal SWEEP.

Alternatively, at least part of the frequency sweep signal lines 34 can be located between the second data signal line 33 and the first constant voltage signal line 31 and electrically connected to the circuit column P3 at the right side, that is, at least part of the frequency sweep signal lines 34 and the second data signal line 33 are located at the same side of the first constant voltage signal line 31 and electrically connected to the same pixel circuit P, thereby reducing the sizes of the signal trace for electrically connecting the second data signal line 33 and the pixel circuit P and the signal trace for connecting the frequency sweep signal line 34 and the pixel circuit P in the first direction X, and taking into account the transmission reliability of the second data signal PAM-data and the frequency sweep signal SWEEP.

It should be noted that in the embodiments of the present application, according to different actual needs, the number of frequency sweep signal lines 34 located between adjacent circuit columns P3 can be one or more. When there are multiple frequency sweep signal lines 34 between two adjacent circuit columns P3, the multiple frequency sweep signal lines 34 may all be located between the first data signal line 32 and the first constant voltage signal line 31, or between the second data signal line 33 and the first constant voltage signal line 31, or part of the frequency sweep signal lines 34 may be located between the first data signal line 32 and the first constant voltage signal line 31, and part of the frequency sweep signal lines 34 may be located between the second data signal line 33 and the first constant voltage signal line 31.

Furthermore, in other embodiments, between adjacent circuit columns P3, at least part of the frequency sweep signal lines 34 may also be located at the side of the first data signal line 32 away from the first constant voltage signal line 31; and/or, at least part of the frequency sweep signal lines 34 may also be located at the side of the second data signal line 33 away from the first constant voltage signal line 31.

In some embodiments, as shown in FIG. 9, the frequency sweep signal line 34 includes a first type of frequency sweep line 341, a second type of frequency sweep line 342, and a third type of frequency sweep line 343, and the first type of frequency sweep line 341, the second type of frequency sweep line 342, and the third type of frequency sweep line 343 are used to drive the pixel circuits P located in different rows along the second direction Y, wherein the first type of frequency sweep line 341 is located between the first data signal line 32 and the first constant voltage signal line 31 that are closest to each other, and the second type of frequency sweep line 342 and the third type of frequency sweep line 343 are located between the second data signal line 33 and the first constant voltage signal line 31 that are closest to each other.

The first type of frequency sweep line 341, the second type of frequency sweep line 342 and the third type of frequency sweep line 343 are all used to transmit the frequency sweep signal SWEEP, but the three are used to drive the pixel circuits P located in different rows along the second direction Y. Exemplarily, the first type of frequency sweep line 341 is used to drive the pixel circuits P in rows 1/4/7 . . . , the second type of frequency sweep line 342 is used to drive the pixel circuits P in rows 2/5/8 . . . , and the third type of frequency sweep line 343 is used to drive the pixel circuits P in rows 3/6/9 . . . .

It should be noted that the embodiments of the present application provides that the frequency sweep signal line 34 includes three signal traces for transmitting the frequency sweep signal SWEEP to the pixel circuits P in different rows, but according to different actual needs, the frequency sweep signal line 34 may also include only one, two or more than three signal traces.

Furthermore, considering that the first type of frequency sweep line 341, the second type of frequency sweep line 342 and the third type of frequency sweep line 343 are simultaneously located between the same adjacent circuit columns P3, if the three signal traces are disposed adjacently and the frequency sweep signal SWEEP is transmitted to the same circuit column P3, the distance between one of the signal traces and the corresponding pixel circuit P in the first direction X may be relatively far, which is prone to cause signal delay problems.

In view of this, in the embodiments of the present application, the first type of frequency sweep line 341 is disposed at both sides of the first constant voltage signal line 31 with respect to the second type of frequency sweep line 342 and the third type of frequency sweep line 343, so that the first type of frequency sweep line 341 is located between the first data signal line 32 and the first constant voltage signal line 31 that are closest to each other, and is electrically connected to the same pixel circuit P as the first data signal line 32. Simultaneously, the second type of frequency sweep line 342 and the third type of frequency sweep line 343 are located between the second data signal line 33 and the first constant voltage signal line 31 that are closest to each other, and are electrically connected to the same pixel circuit P as the second data signal line 33, thereby taking into account the transmission reliability of the frequency sweep signals SWEEP in the various signal traces in the frequency sweep signal line 34, and reducing the risk of signal delay in the frequency sweep signal SWEEP and improving the operation reliability of the pixel circuit P.

In other embodiments, the first type of frequency sweep line 341 and the second type of frequency sweep line 342 can also be located between the first data signal line 32 and the first constant voltage signal line 31, and the third type of frequency sweep line 343 is located between the second data signal line 33 and the first constant voltage signal line 31.

In some embodiments, at least part of the adjacent voltage division signal lines 21 are provided with a same number of circuit rows P4 therebetween. The spacing distance between adjacent voltage division signal lines 21 in the second direction Y can be the same, or there can be a certain difference, which is not limited in the embodiments of the present application.

In combination with the foregoing content, it can be seen that the voltage division signal line 21 is correspondingly located between adjacent circuit rows P4, and only one circuit row P4 can be disposed between adjacent voltage division signal lines 21, or multiple circuit rows P4 can be disposed between adjacent voltage division signal lines 21 at the same time. On this basis, in the embodiments of the present application, at least part of the adjacent voltage division signal lines 21 are provided with the same number of circuit rows P4 therebetween, so that the pixel circuits P and the voltage division signal lines 21 can be arranged in the second direction Y according to a specific rule, thereby reducing the risk of contact interference between the device structure in the pixel circuit P and the voltage division signal line 21, and improving the operation reliability of the pixel circuit P.

In some embodiments, at least part of the voltage division signal lines 21 have a same spacing distance in the second direction Y.

In the embodiments of the present application, by making at least part of the adjacent voltage division signal lines 21 have the same distance in the second direction Y, the voltage division signal lines 21 are arranged more regularly in the second direction Y, thereby reducing the difficulty of signal trace layout in the display panel 100, which is conducive to reducing the risk of contact interference between the voltage division signal line 21 and other signal traces, and improving the reliability of signal transmission.

In some embodiments, in the second direction Y, at least part of the adjacent voltage division signal lines 21 are provided with the N circuit rows P4 therebetween, N≥1; and/or, in the second direction Y, at least part of the adjacent circuit rows P4 are provided with the M voltage division signal lines 21 therebetween, M≥1.

In the embodiments of the present application, considering that for different display panels 100, there are certain differences in the number of circuit rows P4, the distance between adjacent circuit rows P4, and the number of required voltage division signal lines 21 in different display panels 100, on this basis, according to different actual needs, at least part of the adjacent voltage division signal lines 21 can be selectively provided with one or more circuit rows P4 therebetween, or at least part of the adjacent circuit rows P4 can be selectively provided with one or more voltage division signal lines 21 therebetween, so as to adapt to display panels 100 in different situations and improve flexibility.

In some embodiments, as shown in FIG. 7, the display panel 100 includes a repeating circuit group C, the repeating circuit group C includes a plurality of pixel circuits P, and the plurality of repeating circuit groups C are repeatedly arranged in the first direction X and the second direction Y, and the plurality of repeating circuit groups C arranged in the second direction Y form a circuit group column P5, wherein at least part of the adjacent circuit group columns P5 are provided with the first constant voltage signal line 31 therebetween.

Multiple repeating circuit groups C arranged in the second direction Y together constitute a circuit group column P5, and multiple circuit group columns P5 are arranged side by side in the first direction X, and there can be a relatively large gap space between adjacent circuit group columns P5, which is used to arrange signal traces extending along the second direction Y, such as the first constant voltage signal line 31, the first data signal line 32, the second data signal line 33, and the frequency sweep signal line 34.

Further, in the embodiments of the present application, similar to the voltage division signal line 21, the number and arrangement of the first constant voltage signal lines 31 can be flexibly adjusted according to different actual needs, and the first constant voltage signal line 31 can be selected to be disposed only between part of adjacent circuit group columns P5, or the first constant voltage signal line 31 can be selected to be disposed between each adjacent circuit group columns P5, so as to meet different needs and have relatively strong practicality.

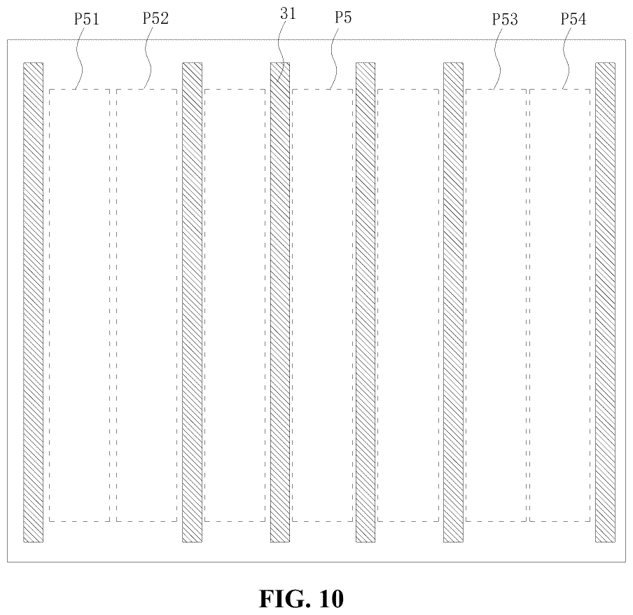

In some embodiments, refer to FIG. 10, the circuit group column P5 includes i circuit group columns P5 arranged at intervals in the first direction X, the first constant voltage signal line 31 is not disposed in the area between the first circuit group column P51 and the second circuit group column P52, and the first constant voltage signal line 31 is provided in the area at the side of the first circuit group column P51 away from other circuit group columns P5; and/or, the first constant voltage signal line 31 is not disposed in the area between the i-1th circuit group column P53 and the i-th circuit group column P54, and the first constant voltage signal line 31 is disposed in the area at the side of the i-th circuit group column P54 away from other circuit group columns P5.

In conjunction with the drawings, i circuit group columns P5 are arranged in the first direction X, and the circuit group column P5 at the far left side is the first circuit group column P51, and the circuit group column P5 at the far right side is the i-th circuit group column P54, which is also the last circuit group column P5.

Depending on actual needs, the structures of the display panels 100 are usually different. For some display panels 100, the circuit group columns P5 at both sides in the first direction X need to be designed to be retracted, that is, the distance between the first circuit group column P51 and the second circuit group column P52 is smaller than the distance between the adjacent circuit group columns P5 in the center of the display panel 100. Similarly, the distance between the i-th circuit group column P54 and the i-1-th circuit group column P53 is smaller than the distance between the adjacent circuit group columns P5 in the center of the display panel 100.

In view of this, in the embodiments of the present application, the first constant voltage signal line 31 is not disposed in the area between the first circuit group column P51 and the second circuit group column P52, thereby reducing the influence of the first constant voltage signal line 31 on the distance between the first circuit group column P51 and the second circuit group column P52. Similarly, the first constant voltage signal line 31 is not disposed at the area between the i-1-th circuit group column P53 and the i-th circuit group column P54, thereby reducing the influence of the first constant voltage signal line 31 on the distance between the i-1-th circuit group column P53 and the i-th circuit group column P54, which is conducive to meeting the shrinking design of the circuit group columns P5 at both sides of the display panel 100 in the first direction X.

Furthermore, in the embodiments of the present application, a first constant voltage signal line 31 is disposed in area at the side of the first circuit group column P51 away from other circuit group columns P5, or a first constant voltage signal line 31 is disposed in the area at the side of the i-th circuit group column P54 away from other circuit group columns P5, so as to meet the quantity requirement of the first constant voltage signal line 31 and improve the transmission reliability of the first power supply voltage PWM-vdd.

In some embodiments, as shown in FIG. 2, the size L1 of the first constant voltage signal line 31 in the first direction X is greater than the size L2 of the voltage division signal line 21 in the second direction Y.

The size L1 of the first constant voltage signal line 31 in the first direction X is the width of the first constant voltage signal line 31, and the size L2 of the voltage division signal line 21 in the second direction Y is the width of the voltage division signal line 21. In the embodiments of the present application, considering that the voltage division signal line 21 can be disposed in the first conductor layer 20 together with a variety of control signal lines 22 and other signal traces, and the number and types of control signal lines 22 are usually relatively large, therefore, in order to reduce the occupation of the space occupied by the voltage division signal line 21 on the control signal line 22 and other signal traces in the first conductor layer 20, the width of the voltage division signal line 21 is designed to be relatively small. As for the first constant voltage signal line 31, since it has a certain design space, its width can be designed to be greater than the width of the voltage division signal line 21, so as to further reduce the resistance value of the mesh structure for transmitting the first power supply voltage PWM-vdd and improve the transmission reliability of the first power supply voltage PWM-vdd.

In some embodiments, sizes L1 of at least part of the first constant voltage signal lines 31 in the first direction X are not less than 10 μm. Optionally, the size L1 of the first constant voltage signal line 31 in the first direction X is one of 10 μm, 15 μm, 20 μm, 50 μm and 80 μm.

In the embodiments of the present application, by setting the size L1 of the first constant voltage signal line 31 in the first direction X to not less than 10 μm, the first constant voltage signal line 31 can have a relatively large width size, thereby reducing the resistance value of the first constant voltage signal line 31, reducing the transmission load of the first power supply voltage PWM-vdd, reducing the risk of signal delay, and improving the operation reliability of the pixel circuit P.

In some embodiments, 2.5 μm≤L2≤50 μm. Optionally, L2 is one of 2.5 μm, 5 μm, 10 μm, 20 μm and 50 μm.

In the embodiments of the present application, by setting the width of the voltage division signal line 21 to not more than 50 μm, it is conducive to reducing the occupation of the space of the film layer where the voltage division signal line 21 is located, and reducing the risk of contact interference between the voltage division signal line 21 and other signal traces in the same layer, thereby improving the reliability of respective signal transmission. At the same time, the width of the voltage division signal line 21 is set to be not less than 2.5 μm, so as to reduce the problem of excessive resistance value caused by the small width of the voltage division signal line 21, thereby improving the transmission reliability of the first power supply voltage PWM-vdd.

In some embodiments, as shown in FIG. 2, the display panel 100 also includes a connecting signal line 23 extending along the first direction X, and the connecting signal line 23 is connected to the first constant voltage signal line 31. The connecting signal line 23 overlaps the orthographic projection of the pixel circuit P on the substrate 10, and the connecting signal line 23 provides a high potential voltage to the pulse width modulation subcircuit P1.

The connecting signal line 23 is a signal trace directly connected to the pixel circuit P in the display panel 100 to directly provide the first power supply voltage PWM-vdd to the pixel circuit P. Similar to the voltage division signal line 21, the connecting signal line 23 also extends along the first direction X and is connected to the first constant voltage signal line 31. However, the difference is that the orthographic projection of the voltage division signal line 21 on the substrate 10 is located outside the orthographic projection of the pixel circuit P on the substrate 10, while the orthographic projection of the connecting signal line 23 on the substrate 10 overlaps the orthographic projection of the pixel circuit P on the substrate 10. According to different design layout conditions, the width of the connecting signal line 23 can be the same as the width of the voltage division signal line 21, or the width of the connecting signal line 23 can be smaller than or larger than the width of the voltage division signal line 21.

In some optional embodiments, the connecting signal line 23 and the voltage division signal line 21 are both located in the first conductor layer 20, and both include the same material and are prepared and formed together in the same process, thereby simplifying the preparation process of the connecting signal line 23 and the voltage division signal line 21 and improving the preparation efficiency.

In the embodiments of the present application, the display panel 100 includes three signal traces, namely, the first constant voltage signal line 31, the voltage division signal line 21 and the connecting signal line 23, for transmitting the first power supply voltage PWM-vdd, and the three can form a mesh structure together, thereby further reducing the transmission load corresponding to the first power supply voltage PWM-vdd and improving the operation reliability of the pixel circuit P. At the same time, the existence of the connecting signal line 23 makes it possible for the orthographic projection of the first constant voltage signal line 31 on the substrate 10 not to overlap the pixel circuit P, thereby reducing the risk of contact interference between the first constant voltage signal line 31 and part of device structures in the pixel circuit P, which is conducive to improving the reliability of respective signal transmission and the preparation yield of the display panel 100.

In some embodiments, the display panel 100 further includes a control signal line 22 extending along the first direction X, and the orthographic projections of the control signal line 22 and the connecting signal line 23 on the substrate 10 overlap the orthographic projection of the same pixel circuit P on the substrate 10.

In the embodiments of the present application, the control signal line 22 and the connecting signal line 23 are both signal trace structures directly connected to the pixel circuit P to directly provide the corresponding signal voltages to the pixel circuit P. Therefore, the orthographic projections of the control signal line 22 and the connecting signal line 23 on the substrate 10 both pass through the orthographic projection of the pixel circuit P, and the two types of signal traces need to overlap the same pixel circuit P to meet the transmission needs of the corresponding signal of the pixel circuit P.

In some optional embodiments, since the connecting signal line 23 and the connecting signal line 23 both overlap the same pixel circuit P, the distance between the connecting signal line 23 and the control signal line 22 is often closer than distance between the connecting signal line 23 and the voltage division signal line 21. On this basis, the width of the connecting signal line 23 can be set to be smaller than the width of the voltage division signal line 21, so as to meet the layout needs of the connecting signal line 23 and the control signal line 22, reduce the risk of contact interference between the two, and improve the reliability of respective signal transmission.

In some embodiments, the control signal line 22 includes a first scanning signal line for transmitting a first type of scanning signal PWM-SCAN to the pulse width modulation subcircuit P1, a first light-emitting control signal line for transmitting a first light-emitting control signal PWM-EM to the pulse width modulation subcircuit P1, a second scanning signal line for transmitting a second type of scanning signal PAM-SCAN to the amplitude modulation subcircuit P2, and a second light-emitting control signal line for transmitting a second light-emitting control signal PAM-EM to the amplitude modulation subcircuit P2.

The control signal line 22 includes multiple types. The first scanning signal line is a signal trace for transmitting the first type of scanning signal PWM-SCAN. Considering that the first type of scanning signal PWM-SCAN includes the first scanning signal PWM-S1 and the second scanning signal PWM-S2, the first scanning signal line includes a first scanning sub-line for transmitting the first scanning signal PWM-S1, and a second scanning sub-line for transmitting the second scanning signal PWM-S2.

The second scanning signal line is a signal trace for transmitting the second type of scanning signal PAM-SCAN. Considering that the second type of scanning signal PAM-SCAN includes the third scanning signal PAM-S1 and the fourth scanning signal PAM-S2, the second scanning signal line includes a third scanning sub-line for transmitting the third scanning signal PAM-S1, and a fourth scanning sub-line for transmitting the fourth scanning signal PAM-S2.

The first light-emitting control signal line is a signal trace for transmitting the first light-emitting control signal PWM-EM, and the second light-emitting control signal line is a signal trace for transmitting the second light-emitting control signal PAM-EM. The first scanning signal line, the second scanning signal line, the first light-emitting control signal line and the second light-emitting control signal line are all used to connect or reuse as control ends of different transistors in the pixel circuit P, so as to realize the control of turning off or on different transistors.

Further, the first scanning signal line, the second scanning signal line, the first light-emitting control signal line and the second light-emitting control signal line all overlap the multiple pixel circuits P in the same repeating circuit group C together with the connecting signal line 23, so that the above-mentioned multiple types of control signal lines 22 and connecting signal lines 23 can be connected to the same pixel circuit P by vias, and directly provide the corresponding signal voltage to the same pixel circuit P, so as to meet the normal operation needs of the pixel circuit P.

In some embodiments, as shown in FIG. 1, the first constant voltage signal line 31 has a first avoidance hole H1, and orthographic projections of at least part of the first avoidance holes H1 on the substrate 10 overlap the orthographic projections of the control signal lines 22 on the substrate 10.

The first avoidance hole H1 is a hole-shaped structure that penetrates the first constant voltage signal line 31. According to different actual needs, the number of the first avoidance hole H1 is one, or the number of the first avoidance holes H1 can also be multiple. When the number of the first avoidance holes H1 is multiple, different first avoidance holes H1 can be arranged along the first direction X, or can also be arranged along the second direction Y, or can also be arranged along the first direction X and the second direction Y at the same time, and the sizes and shapes of the orthographic projections of different first avoidance holes H1 on the substrate 10 can be consistent, or can be different, which is not limited in the embodiments of the present application.

The first avoidance hole H1 is disposed corresponding to the control signal line 22, and the control signal line 22 can have multiple types of signal traces. On this basis, a single first avoidance hole H1 can have multiple position forms with respect to the control signal line 22, for example, at least part of the first avoidance holes H1 can overlap only one control signal line 22, or at least part of the first avoidance holes H1 can also overlap multiple control signal lines 22.

In the embodiments of the present application, considering that the first constant voltage signal line 31 and the control signal line 22 are used to transmit different signals respectively, and the corresponding extension directions of the two intersect, the first avoidance hole H1 is disposed in the first constant voltage signal line 31, and the first avoidance hole H1 overlaps the control signal line 22, thereby reducing the overlapping area between the first constant voltage signal line 31 and the control signal line 22, reducing the parasitic capacitance generated by the overlap between the two, and improving the reliability of respective signal transmission.

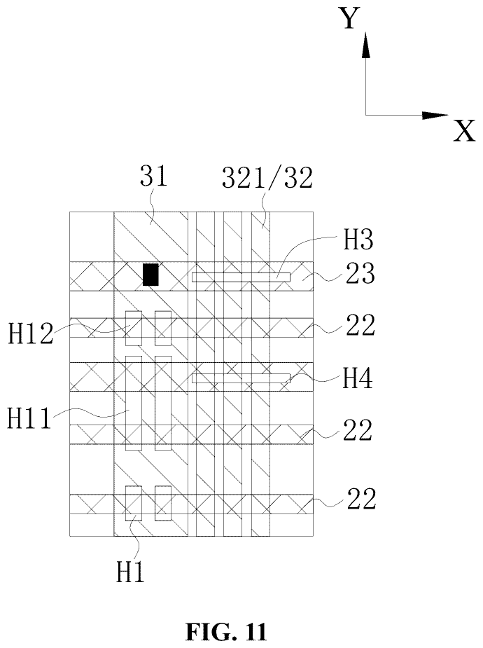

In some embodiments, refer to FIG. 11, the orthographic projections of at least part of the first avoidance holes H1 on the substrate 10 overlap the orthographic projections of multiple control signal lines 22 on the substrate 10.

In the embodiments of the present application, at least part of the first avoidance holes H1 can have a relatively large size in the second direction Y, so as to overlap multiple control signal lines 22 in the second direction Y at the same time. The design of the first avoidance hole H1 with a relatively large size can reduce the crosstalk problem between the first constant voltage signal line 31 and multiple control signal lines 22, while reducing the difficulty of forming the first avoidance hole H1.

In some embodiments, the first avoidance hole H1 includes a first type of avoidance hole H11 and a second type of avoidance hole H12, and the orthographic projection area of the first type of avoidance hole H11 on the substrate 10 is larger than the orthographic projection area of the second type of avoidance hole H12 on the substrate 10.

The number of the first avoidance holes H1 is multiple, and the first avoidance hole H1 includes a first type of avoidance hole H11 with a relatively large size and a second type of avoidance hole H12 with a relatively small size, wherein the size of the first type of avoidance hole H11 in the first direction X may be larger than the size of the second type of avoidance hole H12 in the first direction X; and/or, the size of the first type of avoidance hole H11 in the second direction Y may be larger than the size of the second type of avoidance hole H12 in the second direction Y.

In addition, the orthographic projection of the first type of avoidance hole H11 on the substrate 10 may overlap only one control signal line 22, or may overlap multiple control signal lines 22 at the same time. And the orthographic projection of the second type of avoidance hole H12 on the substrate 10 can also overlap only one control signal line 22, or can also overlap multiple control signal lines 22 at the same time. In other cases, at least one of the first type of avoidance hole H11 and the second type of avoidance hole H12 can also not overlap the control signal line 22, but overlap other signal traces or be used to play other roles, which can also improve the reliability of signal transmission in the first constant voltage signal line 31.

In the embodiments of the present application, the multiple first avoidance holes H1 include large-sized first type of avoidance holes H11, so that the difficulty of hole formation is reduced through the first type of avoidance holes H11, and the preparation yield of the display panel 100 is improved. The multiple first avoidance holes H1 also include small-sized second type of avoidance holes H12, so that the second type of avoidance holes H12 can reduce the adverse effect on the resistance of the first constant voltage signal line 31 as much as possible, thereby further improving the reliability of signal transmission.

In some embodiments, the orthographic projection of the first type of avoidance hole H11 on the substrate 10 overlaps g control signal lines 22, and the orthographic projection of the second type of avoidance hole H12 on the substrate 10 overlap f control signal lines 22; wherein g>f≥1.

Optionally, the size of the first type of avoidance hole H11 in the second direction Y is greater than the size of the first type of avoidance hole H11 in the second direction Y, and the orthographic projection of the first type of avoidance hole H11 on the substrate 10 overlaps the orthographic projections of multiple control signal lines 22 on the substrate 10, while the orthographic projection of the second type of avoidance hole H12 on the substrate 10 overlaps only the orthographic projection of a single control signal line 22 on the substrate 10.

In the embodiments of the present application, the first type of avoidance hole H11 and the second type of avoidance hole H12 both overlap at least one control signal line 22, thereby reducing the signal crosstalk problem between the first constant voltage signal line 31 and the control signal line 22. At the same time, the number of control signal lines 22 overlapping the first type of avoidance hole H11 is set to be greater than the number of control signal lines 22 overlapping the second type of avoidance hole H12, so as to match the sizes of the two with the number of overlapping control signal lines 22 as much as possible, thereby improving the reliability of the design layout of the display panel 100.

In some embodiments, the orthographic projections of part of the first avoidance holes H1 on the substrate 10 are located outside the orthographic projection of the control signal line 22 on the substrate 10, that is, the orthographic projections of part of the first avoidance holes H1 on the substrate 10 overlap the orthographic projection of the control signal line 22 on the substrate 10, and the orthographic projections of part of the first avoidance holes H1 on the substrate 10 do not overlap the orthographic projection of the control signal line 22 on the substrate 10.

It should be noted that part of the first avoidance holes H1 that do not overlap the orthographic projection of the control signal line 22 on the substrate 10 may overlap other signal traces, or may not overlap other signal traces, which is not limited in the embodiments of the present application.

In the embodiments of the present application, since the control signal line 22 usually overlaps the pixel circuit P, part of the first avoidance holes H1 that overlap the control signal line 22 may be located between adjacent pixel circuits P along the first direction X. For the area between adjacent pixel circuits P in the second direction Y, the control signal line 22 is usually not disposed. However, in the embodiments of the present application, the first avoidance hole H1 can be disposed in this area, so that the multiple first avoidance holes H1 can be arranged along specific regular intervals in the second direction Y, which is conducive to reducing the difficulty of forming the multiple first avoidance holes H1 and improving the preparation yield of the display panel 100.

In some embodiments, as shown in FIG. 1 and FIG. 11, the voltage division signal line 21 has a second avoidance hole H2; and/or, the connecting signal line 23 has a third avoidance hole H3.

Similar to the first avoidance hole H1, the second avoidance hole H2 can also be disposed on the voltage division signal line 21, and the risk of signal crosstalk between the voltage division signal line 21 and other signal traces can be reduced by the second avoidance hole H2. The number of second avoidance holes H2 can be one or more, and when the number of second avoidance holes H2 is more than one, the sizes and shapes of different second avoidance holes H2 can be the same, or can be different.

Similarly, the third avoidance hole H3 can also be disposed on the connecting signal line 23, and the risk of signal crosstalk between the connecting signal line 23 and other signal traces can be reduced by the third avoidance hole H3. The number of third avoidance holes H3 can be one or more, and when the number of third avoidance holes H3 is more than one, the sizes and shapes of different third avoidance holes H3 can be the same, or can be different.

In other embodiments, the fourth avoidance hole H4 can also be disposed on the control signal line 22, and the risk of signal crosstalk between the control signal line 22 and other signal traces can be reduced by the fourth avoidance hole H4.

It should be noted that when the first avoidance hole H1 and the fourth avoidance hole H4 exist at the same time, there may be a variety of positional relationships between the first avoidance hole H1 and the fourth avoidance hole H4, for example, the first avoidance hole H1 may overlap the fourth avoidance hole H4, or the two may not overlap, which is not limited in the embodiments of the present application. Optionally, the orthographic projection of the fourth avoidance hole H4 on the substrate 10 is located outside the orthographic projection of the first avoidance hole H1 on the substrate 10, and the orthographic projection of the fourth avoidance hole H4 on the substrate 10 overlaps the orthographic projection of at least one of the data signal line and the frequency sweep signal line 34 on the substrate 10.

In the embodiments of the present application, by disposing at least one of the second avoidance hole H2 and the third avoidance hole H3, it is conducive to reducing the risk of signal crosstalk between the voltage division signal line 21 or the connecting signal line 23 and other signal traces, thereby further improving the reliability of respective signal transmission of various signal traces inside the display panel 100.

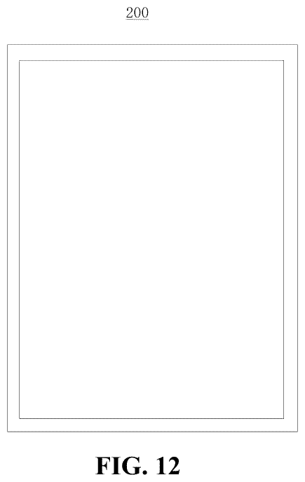

In the second aspect, refer to FIG. 12, the embodiment of the present application provides a display apparatus 200, and the display apparatus 200 includes a display panel in any one of the aforementioned embodiments.

It should be noted that the display apparatus 200 provided in the embodiments of the present application has the beneficial effects of the display panel in any one of the aforementioned embodiments. Refer to the aforementioned description of the beneficial effects of the display panel for details, which is not repeated in the embodiments of the present application.

Although the embodiments disclosed in the present application are as above, the contents described are only embodiments adopted for the convenience of understanding the present application, and are not intended to limit the present application. Any technician in the technical field to which the present application belongs can make any modifications and changes in the form and details of the implementation without departing from the gist and scope disclosed in the present application, but the scope of protection of the present application shall still be subject to the scope defined in the attached claims.

The above are only specific embodiments of the present application, The technicians in the relevant field can clearly understand that for the convenience and simplicity of description, the replacement of other connection methods described above can refer to the corresponding process in the aforementioned method embodiments, and are not repeated here. It should be understood that the protection scope of the present application is not limited thereto, and any technician familiar with the technical field can easily think of various equivalent modifications or substitutions within the technical scope disclosed in the present application, and these modifications or substitutions should be included in the protection scope of the present application.

What is claimed is:

1. A display panel, comprising a pixel circuit, the pixel circuit comprising an amplitude modulation subcircuit and a pulse width modulation subcircuit, the display panel further comprising:
a substrate;
a voltage division signal line, located at a side of the substrate, the voltage division signal line extending along a first direction;
a first constant voltage signal line, located at the side of the substrate, the first constant voltage signal line extending along a second direction and configured to transmit a high potential voltage to the pulse width modulation subcircuit, the first direction intersecting with the second direction,
wherein at least one of the voltage division signal lines is connected to a plurality of the voltage division signal lines.

2. The display panel according to claim 1, wherein the display panel comprises a first conductor layer located at the side of the substrate, the first conductor layer comprises a control signal line and the voltage division signal line extending along the first direction, the control signal line and the voltage division signal line are arranged in the second direction.

3. The display panel according to claim 2, further comprising a second conductor layer disposed at the side of the first conductor layer away from the substrate, the first constant voltage signal line is located in the second conductor layer.

4. The display panel according to claim 3, wherein the second conductor layer further comprises a first data signal line and a second data signal line, the first data signal line is configured to transmit a first data signal to the pulse width modulation subcircuit, and the second data signal line is configured to transmit a second data signal to the amplitude modulation subcircuit;
the first data signal line and the second data signal line both extend along the second direction, and the first constant voltage signal line, the first data signal line and the second data signal line are arranged in the first direction.

5. The display panel according to claim 1, wherein an orthographic projection of the voltage division signal line on the substrate is located outside an orthographic projection of the pixel circuit on the substrate.

6. The display panel according to claim 5, wherein a plurality of the pixel circuits arranged in the second direction form a circuit column, and orthographic projections of at least part of the first constant voltage signal lines on the substrate are located between orthographic projections of the adjacent circuit columns on the substrate;
and/or, a plurality of the pixel circuits arranged in the first direction form a circuit row, and orthographic projections of at least part of the voltage division signal lines on the substrate are located between orthographic projections of the adjacent circuit rows on the substrate.

7. The display panel according to claim 6, further comprising a first data signal line and a second data signal line extending along the second direction, and orthographic projections of at least part of the first data signal lines and the second data signal lines on the substrate are located between the orthographic projections of the adjacent circuit columns on the substrate,
wherein a distance between the circuit column and the first data signal line electrically connected thereto in the first direction is smaller than a distance between the circuit column and the first constant voltage signal line in the first direction; and/or, a distance between the circuit column and the second data signal line electrically connected thereto in the first direction is smaller than a distance between the circuit row and the first constant voltage signal line in the first direction.

8. The display panel according to claim 7, wherein at least part of the adjacent circuit columns are provided with the first constant voltage signal line, the first data signal line and the second data signal line therebetween, the first data signal line and the second data signal line are disposed at both sides of the first constant voltage signal line along the first direction respectively, and the first data signal line and the second data signal line are electrically connected to the pixel circuits in the adjacent circuit columns respectively.

9. The display panel according to claim 7, wherein the display panel comprises a repeating circuit group, the repeating circuit group comprises a plurality of the pixel circuits, and a plurality of the repeating circuit groups are repeatedly arranged in the first direction and the second direction;
the first data signal line comprises a plurality of first sub-data lines, and the plurality of first sub-data lines are electrically connected to the different pixel circuits in the same repeating circuit group respectively; and
the second data signal line comprises a plurality of second sub-data lines, and the plurality of second sub-data lines are electrically connected to the different pixel circuits in the same repeating circuit group respectively.

10. The display panel according to claim 7, further comprising a frequency sweep signal line extending along the second direction, the frequency sweep signal line is configured to transmit a frequency sweep signal to the amplitude modulation subcircuit, and the frequency sweep signal line, the first constant voltage signal line, the first data signal line and the second data signal line are arranged in the first direction.

11. The display panel according to claim 10, wherein at least part of the frequency sweep signal lines are located between the first data signal line and the first constant voltage signal line that are closest to each other, and the frequency sweep signal line and the first data signal line are electrically connected to the same pixel circuit; and/or,
at least part of the frequency sweep signal lines are located between the second data signal line and the first constant voltage signal line that are closest to each other, and the frequency sweep signal line and the second data signal line are electrically connected to the same pixel circuit.

12. The display panel according to claim 11, wherein the frequency sweep signal line comprises a first type of frequency sweep line, a second type of frequency sweep line and a third type of frequency sweep line, and the first type of frequency sweep line, the second type of frequency sweep line and the third type of frequency sweep line are configured to drive the pixel circuits located in different rows along the second direction,
wherein the first type of frequency sweep line is located between the first data signal line and the first constant voltage signal line that are closest to each other, and the second type of frequency sweep line and the third type of frequency sweep line are located between the second data signal line and the first constant voltage signal line that are closest to each other.

13. The display panel according to claim 6, wherein at least part of the adjacent voltage division signal lines are provided with a same number of the circuit rows therebetween; or,
at least part of the adjacent voltage division signal lines have a same spacing distance in the second direction.

14. The display panel according to claim 6, wherein in the second direction, at least part of the adjacent voltage division signal lines are provided with the N circuit rows therebetween, N≥1; and/or,
in the second direction, at least part of the adjacent circuit rows are provided with the M voltage division signal lines therebetween, M≥1.

15. The display panel according to claim 1, further comprising a connecting signal line extending along the first direction, the connecting signal line is connected to the first constant voltage signal line,
wherein the connecting signal line overlaps an orthographic projection of the pixel circuit on the substrate, and the connecting signal line provides the high potential voltage to the pulse width modulation subcircuit.

16. The display panel according to claim 15, further comprising a control signal line extending along the first direction, and orthographic projections of the control signal line and the connecting signal line on the substrate overlap an orthographic projection of the same pixel circuit on the substrate.

17. The display panel according to claim 16, wherein the first constant voltage signal line has a first avoidance hole, and orthographic projections of at least part of the first avoidance holes on the substrate overlap an orthographic projection of the control signal line on the substrate.

18. The display panel according to claim 17, wherein the first avoidance hole comprises a first type of avoidance hole and a second type of avoidance hole, and an orthographic projection area of the first type of avoidance hole on the substrate is larger than an orthographic projection area of the second type of avoidance hole on the substrate.

19. The display panel according to claim 18, wherein an orthographic projection of the first type of avoidance hole on the substrate overlaps the g control signal lines, and an orthographic projection of the second type of avoidance hole on the substrate overlaps the f control signal lines,
wherein g>f≥1.

20. A display apparatus, comprising a display panel comprising a pixel circuit, the pixel circuit comprising an amplitude modulation subcircuit and a pulse width modulation subcircuit, the display panel further comprising:
a substrate;
a voltage division signal line, located at a side of the substrate, the voltage division signal line extending along a first direction;
a first constant voltage signal line, located at the side of the substrate, the first constant voltage signal line extending along a second direction and configured to transmit a high potential voltage to the pulse width modulation subcircuit, the first direction intersecting with the second direction,
wherein at least one of the voltage division signal lines is connected to a plurality of the voltage division signal lines.
